(19) United States
(12) Patent Application Publication
(10) Pub. No.: US 2006/0155499 A1
(43) Pub. Date: Jul. 13, 2006

(54) Method for calibration of digital image-captured devices

(76) Inventor: Wei-Kuo Shih, Pan Chiao City (TW)

Correspondence Address: RABIN & BERDO, P.C.;Suite 500, 1101 14 Street, N.W., Washington, DC, 20005, US

(21) Appl. No.: 11/032,027

(22) Filed: Jan. 11, 2005

(51) Int. Cl. G01C 25/00

(52) U.S. Cl. 702/116

(57) ABSTRACT

A method for calibration of a digital image-captured device is proposed. During assembly process of the digital image-captured device, the present invention first constructs a position table according to a mechanical drawing. Then, when the digital image-captured device is placed on a disposition base, the present invention measures the position value of the digital image-captured device. After that, the present invention maps the position value on a position table of the digital image-captured device to calculate an offset of the digital image-captured device via an interpolation algorithm. Finally, the present invention uses a driving unit to move the digital image-captured device to the predetermined position according to the offset.

### BACKGROUND OF THE INVENTION

1. Field of the Invention

The present invention is related to a method for calibration of digital image-captured devices, and more particularly, to a method used in an assembly process for position calibration of digital image-captured devices. The present invention uses a driving unit to construct a position table, measure the actual position of the digital image-captured device and move the digital image-captured device to a predetermined position according to the position table and the measured result.

2. Description of Related Art

In general, conventional digital image products, such as optical scanners, digital cameras and so forth, have a digital image-captured device disposed in front of their charge-coupled devices (CCD) to capture images. However, the digital image-captured device needs precise position calibration in the assembly process. In the conventional assembly process, the actual installation position of the digital image-captured device is usually not matched with the predetermined position due to the mechanical tolerance. Hence, there is usually a position offset between the actual installation position and the origin position, and the offset value is often located between the preset upper and lower tolerant values due to the tolerance management. Thus, in order to correct this deviation, the position calibration needs to be performed in the assembly process of the digital image-captured devices.

Reference is made to FIG. 1, which is a schematic diagram illustrating the distance apart from the origin position versus the rotation angle of a conventional digital image-captured device of a digital camera. Therein, points A and B represent the predetermined upper and lower tolerant values. Due to the position offset, auto focus (AF) complied with a depth-of-field table of the digital image-captured device usually fails. It causes the defocus of the digital image-captured device and makes the digital image-captured device unable to capture clear images.

In order to resolve this problem, a calibration method for the digital image-captured device was proposed. An axial position adjustment is first performed on the digital image-captured device within a disposition base and then fixes the same on the disposition base after the position adjustment. In this calibration method, the digital image-captured device is directly moved within the disposition base for adjustment. However, the position adjustment of the digital image-captured device needs a precise operation and is hard to be performed. Besides, this method is time-consuming, laborious and inconvenient for installation of the digital image-captured device.

Accordingly, as discussed above, the prior art still has some drawbacks that could be improved. The present invention aims to resolve the drawbacks in the prior art.

### SUMMARY OF THE INVENTION

The present invention provides a method for calibration of a digital image-captured device. In the assembly process of the digital image-captured device, the present invention uses a pre-constructed position table to find the position offset of the digital image-captured device. Then, the present invention uses a driving unit to move the digital image-captured device to the predetermined position according to the position offset obtained.

The present invention provides a method for calibration of a digital image-captured device. In the method, a position table is first constructed according to a mechanical drawing and then saved. Then, when the digital image-captured device is placed on a disposition base, the present invention measures the position of the digital image-captured device. After that, the present invention uses the position value and the position table to find the position offset of the digital image-captured device via an interpolation algorithm and stores the offset value. Thus, when the digital image product is turned on, the present invention can use a driving unit to move the digital image-captured device to the predetermined position according to the offset value.

In the description above, the driving unit can be a stepper motor, and the position table includes an upper position limit value, a lower position limit value and an origin position value, which are obtained by counting the steps needed to be taken by the stepper motor. In addition, during assembly, the installation position of the digital image-captured device is also measured by counting the steps taken by the stepper motor. Then, an arithmetic unit of the digital image product uses the measured value of the installation position and the position table to find the position offset via the interpolation algorithm. Finally, the driving unit moves the digital image-captured device to the predetermined position according to the offset.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram illustrating the distance apart from the origin position versus the rotation angle of a conventional digital image-captured device for a digital camera;

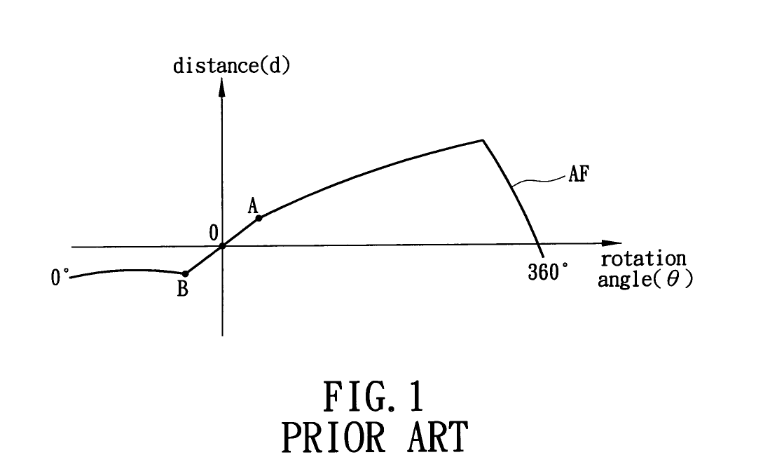

FIG. 2 is a flowchart of a preferred embodiment in compliance with the present invention;

FIG. 3 is a schematic diagram for illustrating the distance apart from the origin position versus rotation angle of a digital image-captured device in accordance with the present invention; and

FIG. 4 is an embodiment of the position table in accordance with the present invention.

### DETAILED DESCRIPTION OF PREFERRED EMBODIMENTS

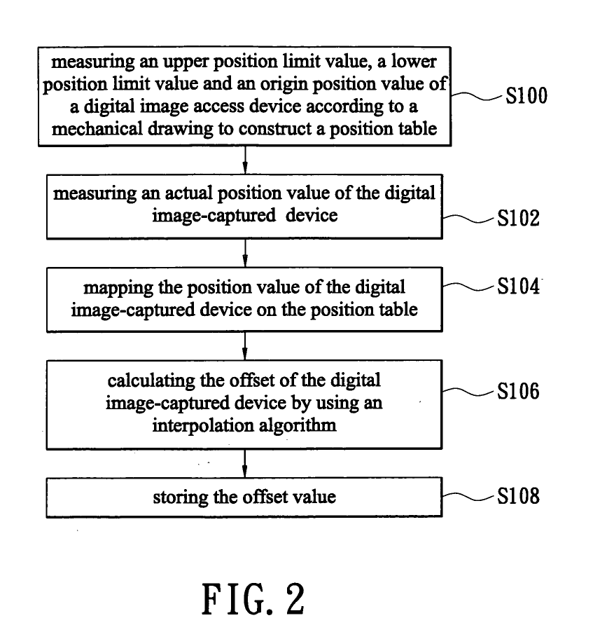

Reference is made to FIG. 2, which is a flowchart of a preferred embodiment according to the present invention. It includes the following steps of: measuring an upper position limit value, a lower position limit value and an origin position value of a digital image-captured device within a disposition base according to a mechanical drawing to produce a position table (S100); measuring a position value of the actual disposition position of the digital image-captured device (S102); mapping the position value of the digital image-captured device to the position table (S104); calculating a position offset of the digital image-captured device by using an interpolation algorithm (S106); and storing the offset value (S108) or performing the calibration process every time the digital image system is turned on for improving precision.

The present invention provides a calibration method to improve the conventional assembly process of the digital image-captured device and remove the position offset of digital image-captured device. Thus, the present invention makes the AF function which is complied with the depth-of-field table be performed regularly. In step S100, the present invention counts the steps needed to be taken by a driving unit to measure the upper position limit value, the lower position limit value and the origin position value according to the mechanical drawing of the digital image-captured device and the disposition base. The driving unit is a stepper motor, a hypersonic motor or the like.

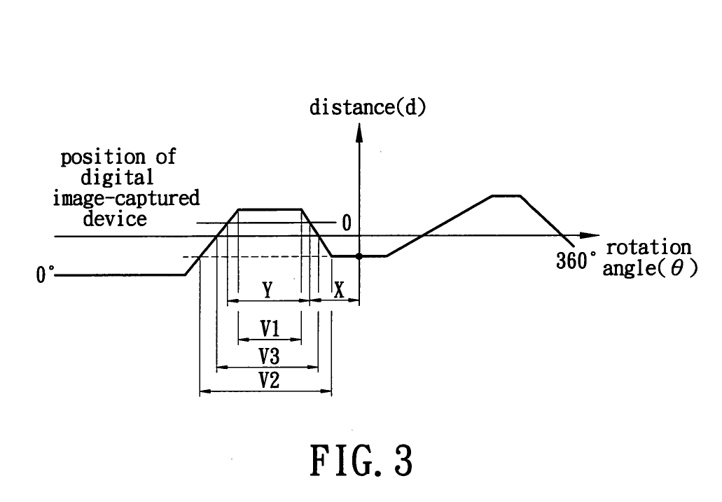

Reference is made to FIG. 3, which is a graph illustrating the distance apart from the origin position versus the rotation angle of a digital image-captured device in accordance with the present invention. Therein, the vertical axis represents the distance d of the digital image-captured device apart from the origin position and the horizontal axis represents the rotation angle θ of the driving unit. In the present invention, the driving unit rotates to drive a cam (not shown) to move the digital image-captured device forward or backward. Referring also to FIG. 2, the present invention counts the steps needed to be taken by the driving unit to measure the upper position limit value V1, the lower position limit value V2 and the origin position value V3 according to the mechanical drawing of the digital image-captured device and its disposition base. Then, these values are stored to construct the position table of the digital image-captured device. In addition, the position table also includes the offsets of the upper position limit value V1, the lower position limit value V2 and the origin position value V3. The offsets is also obtained by counting the steps needed to be taken by the driving unit according to the mechanical drawing of the digital image-captured device and its disposition base.

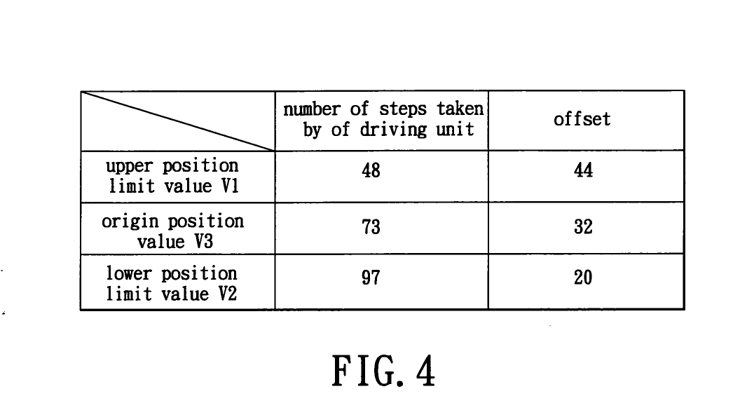

Reference is made to FIG. 4, which is an embodiment of the position table in accordance with the present invention. Therein, the upper position limit value V1 of the digital image-captured device is 48 and its offset is 44. This means that the driving unit takes 44 steps to move the digital image-captured device from the position corresponding to the upper position limit value V1 to the origin position. Likewise, the offsets of the lower position limit value V2 and the origin position value V3 are obtained in the same way.

Reference is made to FIG. 3 again. In this embodiment, the position table is stored after it is constructed. Furthermore, when the digital image-captured device is disposed on a disposition base, the present invention counts the steps taken by the driving unit to measure the position of the digital image-captured device according to the mechanical drawing of the digital image-captured device and the disposition base to obtain a position value Y and store the same. The position value Y represents the number of the steps taken by the driving unit. The present invention uses the position value Y, the position table and an interpolation algorithm to obtain the offset X of the digital image-captured device. Finally, the present invention moves the digital image-captured device to the predetermined position according to the offset X for position calibration.

Summing up, the present invention constructs and stores a position table, including an upper position limit value, a lower position value and an origin position value, by counting steps taken by the driving unit before assembly of the digital image-captured device. During assembly, the present invention measures and stores the position value of the actual installation position of the digital image-captured device by counting steps taken by the driving unit. Then, the present invention uses the position value of the digital image-captured device, the position table and an interpolation algorithm to obtain the offset of the digital image-captured device. Finally, the present invention uses the driving unit to move the digital image-captured device to the predetermined position according to the offset for position calibration.

In addition, the present invention can perform a simple calculation for position calibration before digital image products start the auto focus function. In the simple calculation, the present invention performs an interpolation algorithm according to the stored position table and the position value of the digital image-captured device to obtain the offset of the digital image-captured device. Then, the driving unit moves the digital image-captured device to the predetermined position according to the offset for finishing the position calibration. Hence, the present invention has advantages as follows:
(1) The reference of the origin position is exact;
(2) The origin position of the digital image-captured device is not affected by mechanical tolerance; and
(3) The factor that makes the auto focus function fail is removed.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for calibration of an digital image-captured device, the method being used for an assembly process of the digital image-captured device, the method comprising:
constructing a position table according to a mechanical drawing;
measuring a position value of an actual position of the digital image-captured device;
mapping the position value of the digital image-captured device on the position table; and
calculating a offset of the digital image-captured device;
wherein the digital image-captured device is moved to a predetermined position according to the offset via a driving unit.

2. The method as claimed in claim 1, wherein the position table includes an upper position limit value, a lower position limit value and an origin position value.

3. The method as claimed in claim 2, wherein the upper position limit value, the lower position limit value and the origin position value are numbers of steps taken by the driving unit.

4. The method as claimed in claim 1, wherein the step for measuring is performed by using the mechanical drawing or a physical object.

5. The method as claimed in claim 1, wherein the position value of the digital image-captured device represents a number of steps taken by the driving unit.

6. The method as claimed in claim 1, wherein the step of calculating is performed by using an interpolation algorithm after mapping the position value of the digital image-captured device to the position table.

7. The method as claimed in claim 1, wherein the offset represents a number of steps taken by the driving unit.

8. The method as claimed in claim 1, wherein the step of calculating the offset is followed by a step of storing the offset.

9. A method for calibration of an digital image-captured device, used for a assembly process of the digital image-captured device, the method comprising:
constructing a position table;
measuring an actual position of the digital image-captured device to obtain a position value;
mapping the position value on the position table; and
calculating an offset of the digital image-captured device;
wherein the digital image-captured device is moved to a predetermined position according to the offset via a driving unit.

10. The method as claimed in claim 9, wherein the position table is constructed according to a mechanical drawing.

11. The method as claimed in claim 9, wherein the position table includes an upper position limit value, a lower position limit value and an origin position value.

12. The method as claimed in claim 11, wherein the upper position limit value, the lower position limit value and the origin position value represent numbers of steps taken by the driving unit.

13. The method as claimed in claim 9, wherein the step for measuring is performed by using a mechanical drawing or a physical object.

14. The method as claimed in claim 9, wherein the position value of the digital image-captured device represents a number of steps taken by the driving unit.

15. The method as claimed in claim 9, wherein the step of calculating is performed by using an interpolation algorithm after mapping a position value of the digital image-captured device on the position table.

16. The method as claimed in claim 9, wherein the offset represents a number of steps taken by the driving unit.

17. The method as claimed in claim 9, wherein the step of calculating the offset is followed by a step of storing the offset.
